(19) United States
(12) Patent Application Publication
(10) Pub. No.: US 2006/0077610 A1
(43) Pub. Date: Apr. 13, 2006

(54) Motor overload protector

(76) Inventors: Adrian W. Lim, North Attleboro, MA (US); Russell P. Brodeur, Rehoboth, MA (US)

Correspondence Address: TEXAS INSTRUMENTS INCORPORATED, 34 FOREST STREET, MS 20-21, ATTLEBORO, MA, 02703, US

(21) Appl. No.: 11/179,141

(22) Filed: Jul. 12, 2005

Related U.S. Application Data
(60) Provisional application No. 60/618,083, filed on Oct. 12, 2004.

(51) Int. Cl. H02H 5/04

(52) U.S. Cl. 361/103

(57) ABSTRACT

An enclosed motor protector has a housing formed by a base (10) and a cover (12) received on the base and enclosing a recess (10a) formed in the base. A first terminal (14) extends through an opening in the housing and mounts a stationary contact (14c) within the recess. An elongated movable contact arm (18) is cantilever mounted at one end in the recess and mounts a second movable contact (18a) on a free end of the arm which is adapted to move into and out of engagement with the stationary contact. A heater (20) is mounted in the recess in heat transfer relation with a snap acting thermostatic disc (22) disposed adjacent to the movable contact arm so that upon reaching a preselected temperature the disc will snap from one dished configuration to an opposite dished configuration with its motion transferred to the movable contact arm to move the contacts out of engagement. The cover is formed with a first multiple wall barrier (122) in the form of a triangular body when seen in a lateral cross section closing a first terminal receiving opening and a second multiple wall barrier (124) closing a second terminal receiving opening to interrupt the travel of arcs and the inlet of explosive gas to the enclosure. These features also diminish air supply in the enclosure to thereby weaken any combustion.

### CROSS-REFERENCE TO RELATED APPLICATIONS

Priority is claimed under 35 U.S.C. Section 119(e) (1) of Provisional Application No. 60/618,083, filed Oct. 12, 2004.

### FIELD OF THE INVENTION

This invention relates generally to motor protectors and more particularly to electrical enclosed break devices.

### BACKGROUND OF THE INVENTION

U.S. Pat. No. 4,706,152, assigned to Texas Instruments Incorporated, relates to an enclosed break device known as the 4TM and the 5TM. An enclosed break device, according to the International Electrotechnical Commission (IEC) Standard 60079-15 second edition 2001-02, is a “device incorporating electrical contacts that are made and broken and that will withstand an internal explosion of the flammable gas or vapor which may enter it without suffering damage and without communicating the internal explosion to the external flammable gas or vapor.” The 4TM and 5TM devices which have been made in accordance with the referenced patent comply with the first edition of the IEC standard 60079-15 which requires that enclosed break devices pass a make-and-break test 3 times without communicating an internal explosion to external flammable gas or vapor.

However, such devices may not meet the requirement of the second edition IEC Standard 60079-15, which requires that an enclosed break device pass a make-and-break test 10 times.

### SUMMARY OF THE INVENTION

It is an object of the present invention to provide a 4TM/5TM type device that complies with the second edition (2001-02) IEC Standard 60079-15.

Another object of the invention is the provision of an internal break device that can be subjected to a make-and-break test ten times without communicating an internal explosion to external flammable gas or vapor.

A conventional 4TM/5TM type device comprises a base of electrically insulative material in which an elongated recess is formed. A first terminal is mounted at a first end and provided with a contact mounting portion disposed within the recess with a stationary contact mounted thereon. An elongated movable contact arm has a first end fixedly mounted on a mounting portion connected to another terminal. A movable contact is mounted on a free end of the movable contact arm and is arranged to move into and out of engagement with the stationary contact. A well is formed intermediate to the ends of the elongated recess and a heater is disposed therein in heat transfer relation to a thermostatic disc seated in the base over the well. The disc is adapted to snap from one dished configuration to an opposite dished configuration upon being heated to a preselected temperature. When the disc snaps it transfers motion to the movable contact arm causing the movable contact to move out of engagement with the stationary contact thereby interrupting the circuit path therethrough. A cover of electrically insulative material is received on the base to enclose the switch mechanism. However, there are two paths leading from the electrical contacts to openings at locations between the cover and base where the cover side wall is not interdigitated with the base, or closed, with a notched seating ledge of the base or comparable blocking protrusions of the cover. These locations allow flammable gas outside the protector housing to enter into the housing and enable internal arcing to ignite the flammable gas outside the device. The first path is shown by lines 2a of FIGS. 3 and 6 which extend directly from the contacts through slots/openings between the first terminal blade portion and the side walls of the slots/openings of the base and the cover. The second path is shown by lines 2b (FIG. 3) which extends from the contacts over the wall at the back portion of the contact receiving end of the recess.

According to a preferred embodiment of the invention, the cover is modified by forming first and second multiple wall barriers to impede the travel of arcs from the make-and-break contacts. The first multiple wall barrier comprises spaced apart wall portions which are received on the mounting portion of the first terminal closely adjacent to the stationary and movable contacts. According to a feature of the invention, the wall portions form a generally triangular configuration with respect to a cross section taken parallel to the bottom wall of the base. This structure also serves to decrease the volume of space between the base and cover thereby minimizing the supply of fuel to an internal explosion. According to another modification of the cover a vertically extending notch is formed in the walls which interfit with a corner portion of a corresponding side wall of the base to further inhibit arc travel.. The second multiple wall barrier comprises another set of spaced apart wall portions along the perimeter of the base at a side of the first end of the recess to limit travel of arcing from the contacts and to further decrease excess volume of space. In another preferred embodiment of the invention, the various openings formed in the housing of the device are sealed by epoxy to prevent propagation of any internal explosion from external flammable gas. The sealing can be utilized by itself or along with the cover modifications noted above.

### BRIEF DESCRIPTION OF THE DRAWINGS

Other objects and features of the invention will become apparent by reference to the following detailed description of preferred embodiments when considered in connection with the accompanying drawings in which like reference characters refer to like components or structural features throughout the several views wherein:

FIG. 1 is a perspective view of a 4TM/5TM device taken from above the device;

FIG. 2 is a perspective view of the FIG. 1 device taken from the same position but with the device rotated half a turn upwardly into the paper as seen in FIG. 1;

FIG. 3a is a top plan view of the base of the device prior to the installation of components therein and FIG. 3b is a view similar to FIG. 3a shown at a slight angle relative to the position of FIG. 3a to better illustrate the relative heights of the various surfaces of the base;

FIG. 4 is a perspective view of the cover of the FIG. 1 device as it existed prior to the instant invention taken generally in the FIG. 2 orientation;

FIG. 5a is a top plan view of the FIG. 1 device as it existed prior to the instant invention with the cover removed; FIG. 5b is the same as FIG. 5a but with the snap acting disc removed for purposes of illustration; and FIG. 5c is the same as FIG. 5a but with the disc and heater element removed for purposes of illustration;

FIG. 6 is a broken away cross section in the direction of a front elevational view of FIGS. 5a-5c device taken through the make-and-break contacts;

FIG. 7 is a view similar to FIG. 4 of a cover made in accordance with a preferred embodiment of the invention;

FIG. 8 is a view similar to FIG. 5a but is shown with a cover in a horizontal cross section, the cover incorporating the preferred embodiment shown in FIG. 7;

FIG. 9 is a top plan view of a 4TM and 5TM device made in accordance with the preferred embodiment of FIGS. 7 and 8;

FIG. 10 is an elevational cross section taken on line 10-10 of FIG. 9;

FIG. 11 is an elevational cross section taken on line 11-11 of FIG. 9;

FIG. 12 is an elevational cross section taken on line 12-12 of FIG. 9;

FIG. 13 is a view similar to FIG. 8 but showing an alternative preferred embodiment of the invention;

FIG. 14 is a perspective view, similar to FIG. 1 of a device made in accordance with the FIG. 13 preferred embodiment;

FIG. 15 is a perspective view, similar to FIGS. 8 and 13 showing another alternative preferred embodiment of the invention; and

FIG. 16 is a view similar to FIG. 15 of a device made according to the FIG. 15 embodiment.

### DETAILED DESCRIPTION OF PREFERRED EMBODIMENTS

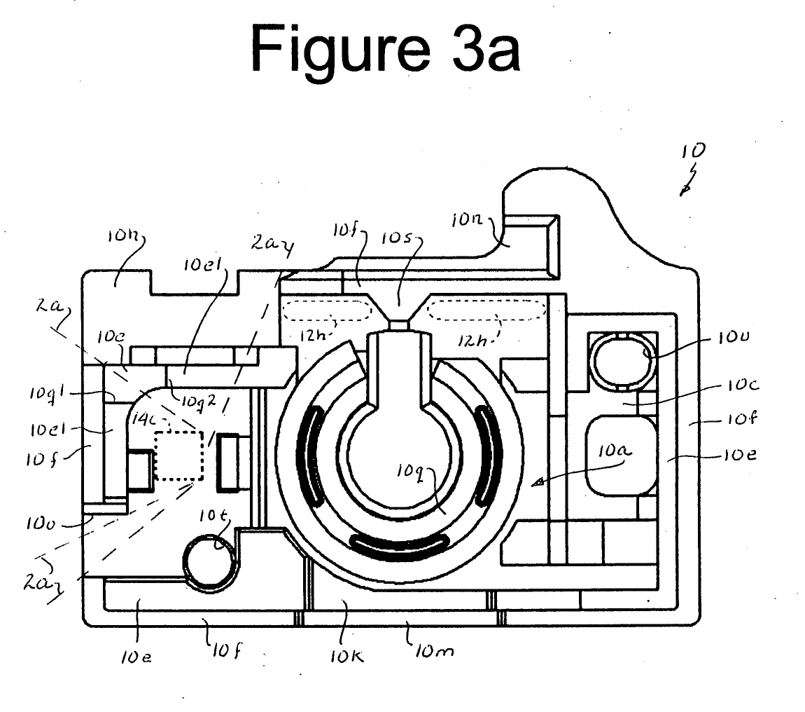

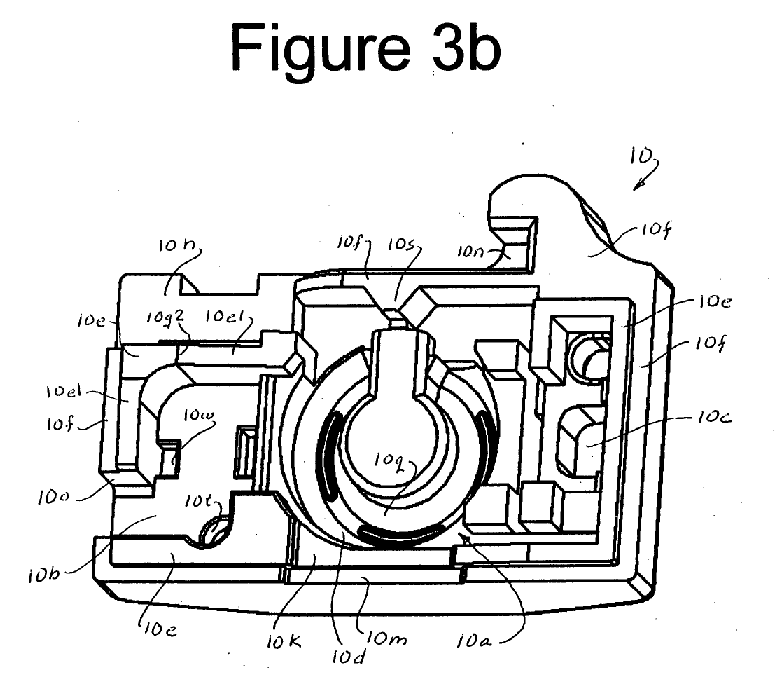

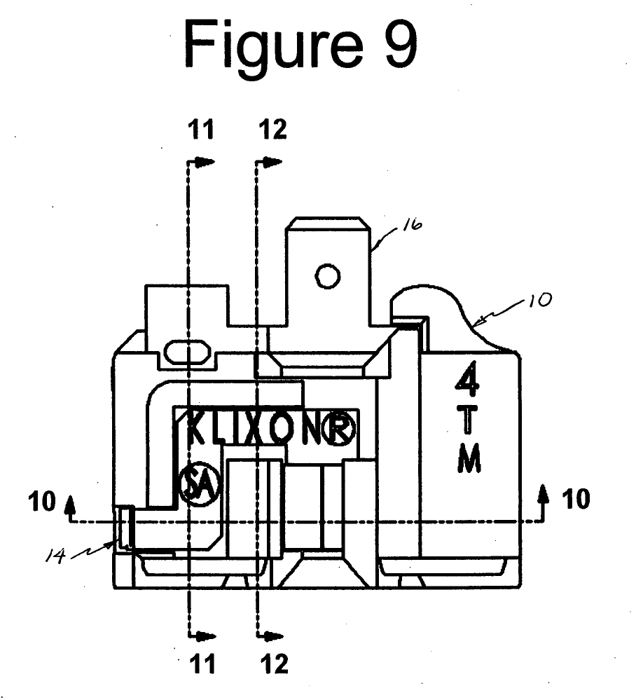

In the following description references made to top, bottom, side and the like relate to the orientation of the device as shown in FIGS. 3, 5, 8, 9, 13 and 15.

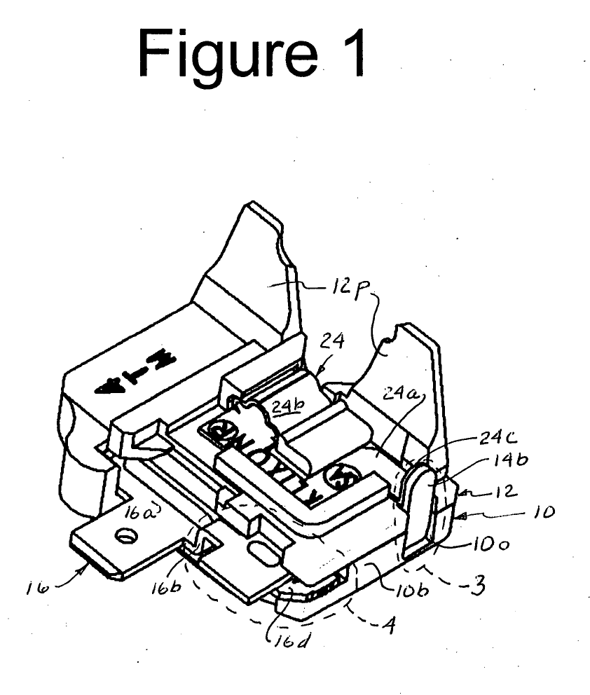

With reference to FIGS. 1-5, the 4TM and 5TM devices referenced above comprise a housing having a generally rectangular base 10 having a major length along the front of the device and a minor length from front to back of the device. A recess 10a is formed in the base and a cover 12 is received thereon closing the recess. First and second guide pin holes 10t, 10u are formed in the bottom wall for reception of cover guide pins 12d, 12e, respectively, to be discussed. With particular reference to FIG. 3, recess 10a is generally elongated in the direction of the major length having a contact receiving end 10b, an opposite movable contact arm mounting end 10c and a central heater receiving portion 10d intermediate to the two ends. Contact receiving end 10b of the recess is defined by side wall portions 10e on the front, and 10e and 10e1 tapered downwardly from line 10g1 on the left side of the base as seen in FIG. 3 with an offset lower seating ledge 10f contiguous with these portions on the front and left sides. The back side of the contact receiving end of the recess is defined by wall portion 10e with a downward tapered portion extending from line 10g on to the right extreme of that wall portion as viewed in FIG. 3. As will be discussed below, there is no seating ledge along the back portion of the contact receiving end of the recess. Outboard of the back side of the contact receiving end of the recess defining wall is a downwardly spaced terminal receiving ledge 10h. Central heater receiving portion 10d is defined on the front by a downwardly offset portion 10k along with an outer downwardly further offset ledge 10m and on the back side by wall portion 10f. Outboard of wall portion 10f defining the central heater receiving portion 10d of the recess is another terminal receiving ledge 10n offset further downwardly than terminal receiving ledge 10h, i.e., ledge 10n is closer to the bottom wall of the base than is ledge 10h. The movable contact arm mounting end 10c of the recess is defined by side wall 10e with outer wall portion 10f serving as a seating ledge.

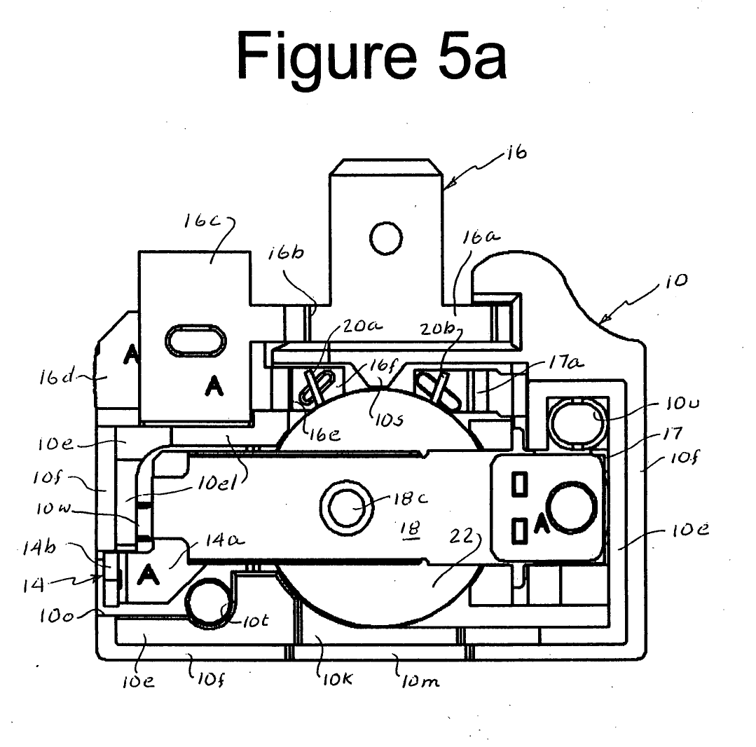

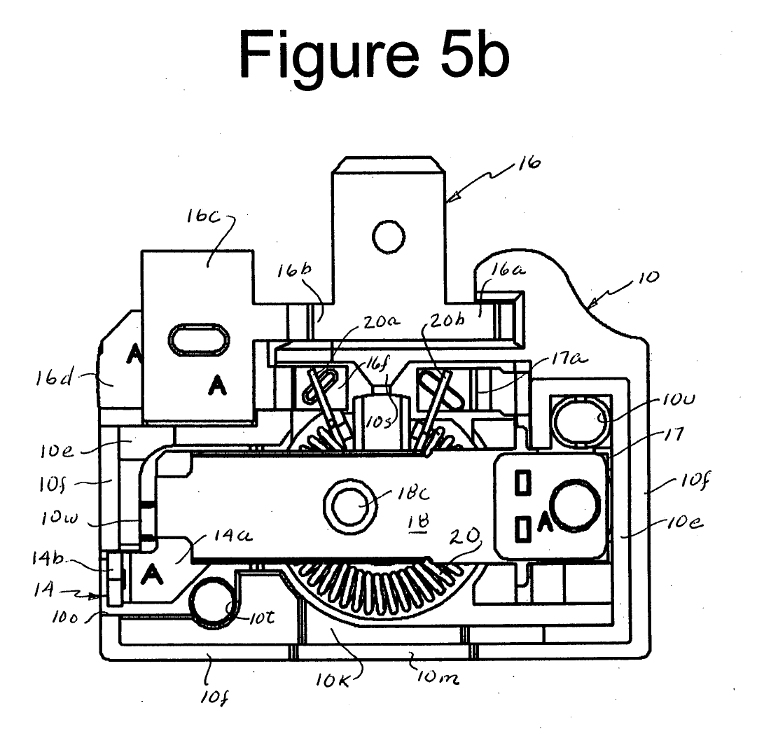

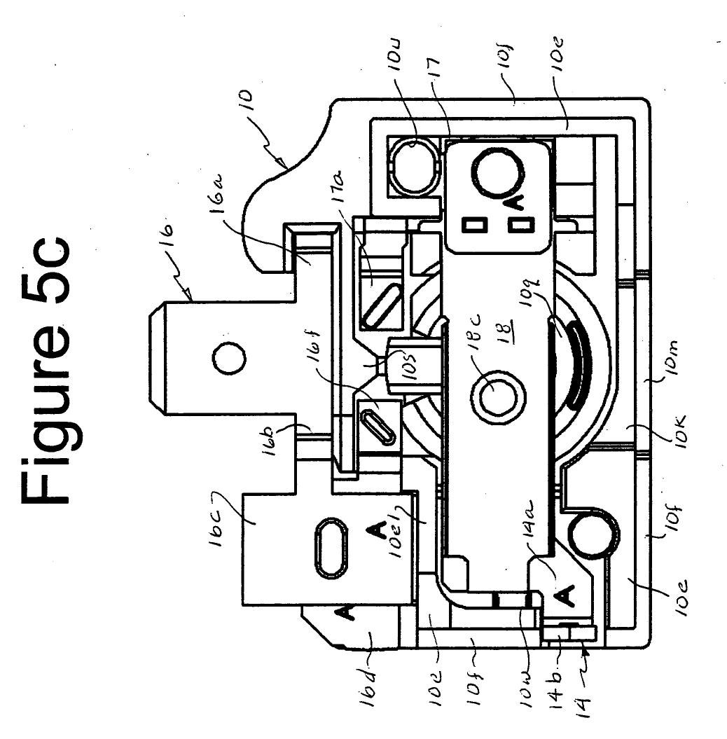

With particular reference to FIGS. 3 and 5a, a slot 10o is formed in side wall 10e defining the left side of contact receiving end 10b of the recess for reception of a first terminal 14 to be discussed. A second terminal 16 has a base portion 16a received on ledge 10n and has a transversely extending step portion 16b extending up to a higher level to a body portion 16c. A separate electrically conductive terminal strip 16d is received on terminal receiving ledge 10h and is provided with a transversely extending step portion 16e extending down to the bottom of the central heater receiving recess portion in a space 10r between wall portion 10f defining the back of the central heater receiving portion of the recess and the central heater receiving portion of the recess 10d with the end 16f of strip portion 16d serving as a connection location for one end 20a of a heater 20, to be discussed, disposed in an annular well 10q in the recess. The body portion 16c of the second terminal 16 is fixedly and electrically connected to terminal strip 16d on ledge portion 10h, as by welding.

First terminal 14 has a first, generally flat mounting portion 14a disposed at the contact receiving end 10b of recess 10a, an arm 14d which projects downwardly through an opening 10w in the bottom wall of the base and formed with a pair of clamping fingers 14e which are spread apart after being received through opening 10w to secure the mounting portion. First terminal 14 has a second portion 14b that includes an interconnection blade portion extending out of an opening in the side wall of the housing.

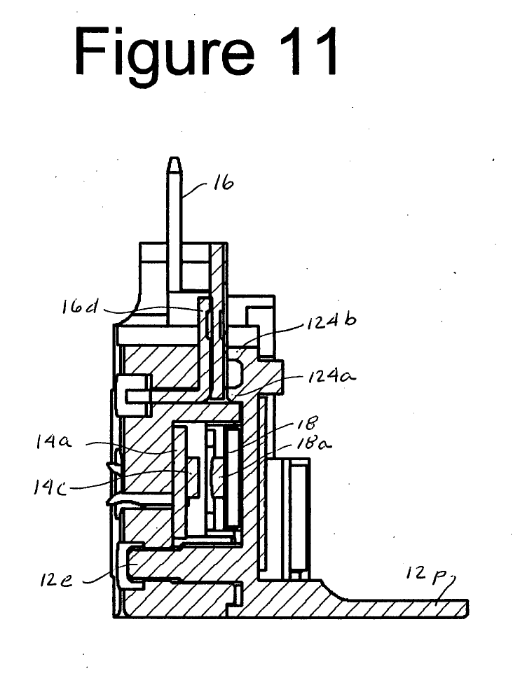

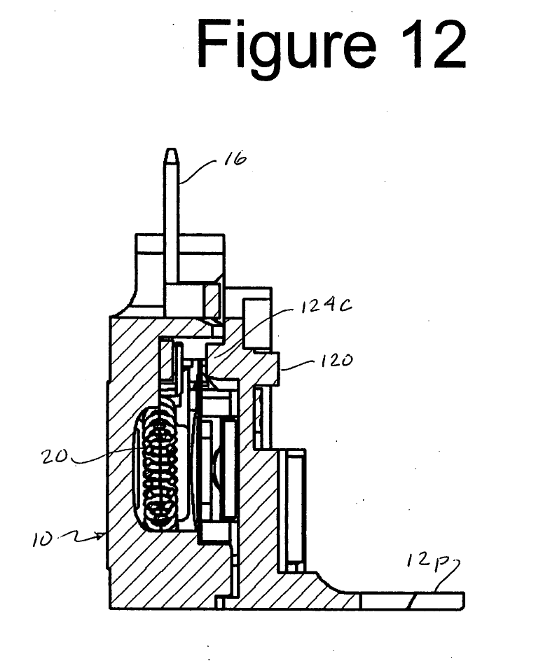

An electrically conductive movable contact arm mounting platform 17, see FIGS. 5a and 11, received in movable contact arm mounting end 10c of recess 10a, is provided with an arm that steps down to an end portion 17a at a location in annular well 10q on the opposite side of a vertically extending rib 10s of wall 10f from end 16f of strip portion 16d. End portion 17a of the arm of platform 17 serves as a connection point for the second end 20b of heater 20. Platform 17 is fixedly and electrically connected to an end 18b of an elongated movable contact arm 18 which extends in the direction of the major length of recess 10a. A movable contact 18a is mounted on the bottom surface of movable contact arm 18 at its free end and is arranged to move into and out of electrical engagement with a stationary contact 14c mounted on mounting portion 14a of the first terminal.

A third pin receiving terminal 24 (FIG. 1) has a body portion 24a received on the top surface of cover 12 with pin receiving portion 24b aligned with the space between ears 12p of the cover. Terminal 24 has an arm 24c which extends over to the blade portion 14b of first terminal 14 and is electrically connected thereto, as by welding.

As noted above, heater 20 (see FIG. 5b) is disposed in well 10q of central heater receiving portion 10d of recess 10a and a thermostatic, snap acting disc 22 (see FIG. 5a) is received on a disc seat formed in that portion of recess 10d so that the disc is above the heater in heat transfer relation therewith. Disc 22 is arranged so that at normal ambient temperature the disc is in a first dished shape configuration out of engagement with movable contact arm 18 however, upon reaching a predetermined actuation temperature, the disc snaps to a second, opposite dished configuration engaging dimple 18c of movable contact arm 18 and moves the movable contact 18a out of engagement with stationary contact 14c thereby opening the electrical path between terminals 16 and 18.

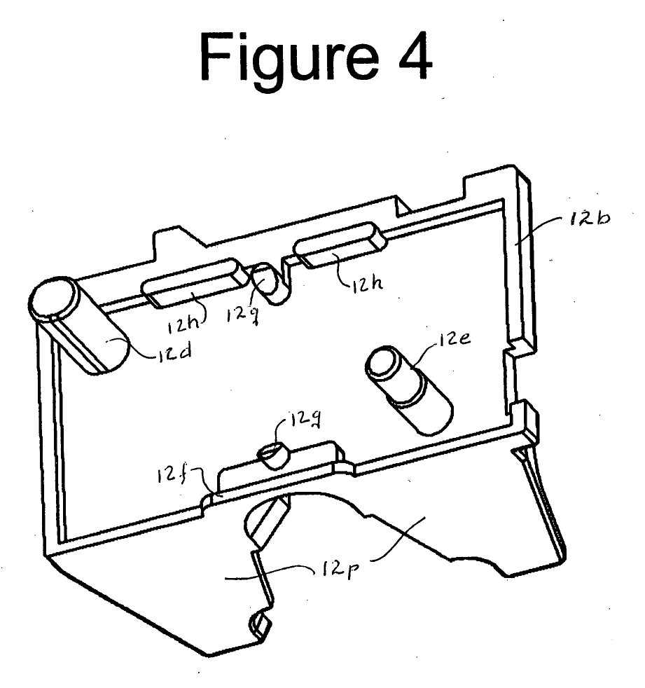

Cover 12, shown best in FIG. 4 and shown inverted relative to FIG. 1, is formed with a recess closing wall 12a and side walls 12b formed generally around the outer perimeter of recess closing wall 12a and extend orthogonally therefrom side walls 12b are alignable with seating ledge portion 10f of side walls 10e of base 10. A slot or opening 12c formed in side wall 12b, extends into recess closing wall 12a and is alignable with slot or opening 10o in the base, to provide access for blade portion 14b of terminal 14. First and second alignment posts 12d, 12e, respectively, extend orthogonally from recess closing wall 12a and are adapted to be received in matching bores 10t, 10u, respectively, in base 10. Side wall 12b is extended in height at central front portion 12f and is adapted to be received on seating ledge 10m of the base, i.e., extending beyond wall portion 10k to provide an interdigitated or closed fit with wall portion 12f received in a step between wall portion 10k and 10m. Also shown in FIG. 4 are first and second disc retaining pins 12g disposed at opposed locations alignable with outer peripheral portions of the disc seat. First and second elongated blocks 12h are formed on wall 12a extending along the major wall length contiguous with side wall 12b on either side of one of the disc retaining pins and extending in height beyond side wall 12b.

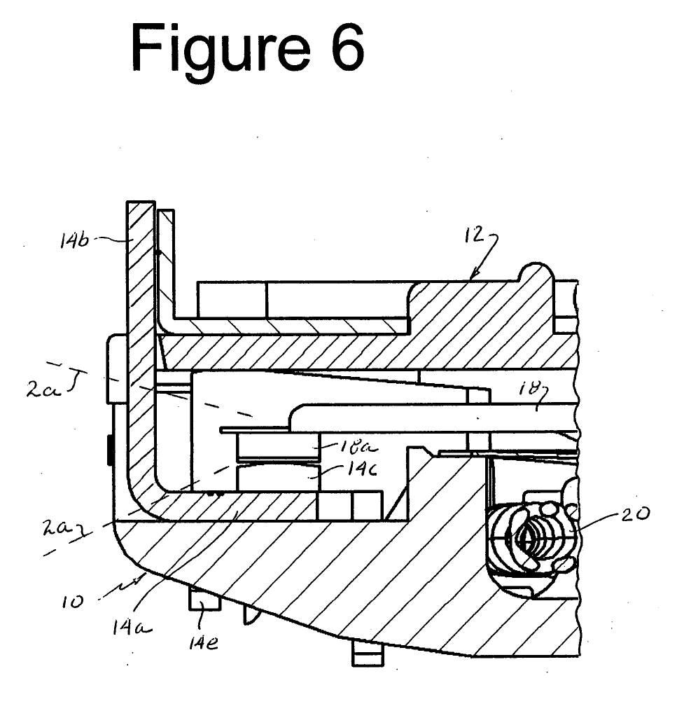

Although protectors made as shown in FIGS. 1-5 have performed extremely well and have been widely used in various industries, certain aspects of the devices need to be modified to ensure that the devices comply with recent changes in the requirements of the International Electrotechnical Commission Standard relating to “enclosed break devices” discussed above. With particular reference to FIGS. 3, 5a-5c and 6, there are two paths leading from contacts 18a, 14c to openings at locations between the cover and the base where the cover side wall is not interdigitated with the base, or closed, with a notched seating ledge of the base, or the like. These locations allow flammable gas outside the protector housing to enter into the housing and enable internal arcing to ignite the flammable gas outside the device. The first path is shown by lines 2a (FIGS. 3 and 6) which extend directly from the contacts through slots/openings 10o of the base and 12c of the cover between terminal blade portion 14b and the side walls of slots/openings 10o of base 10 and 12c of cover 12. The second path is shown by lines 2b (FIG. 3) which extends from the contacts over wall 10e and 10e1 at the back portion of contact portion end 10b of recess 10a and wall 10f of the central heater receiving recess 10d.

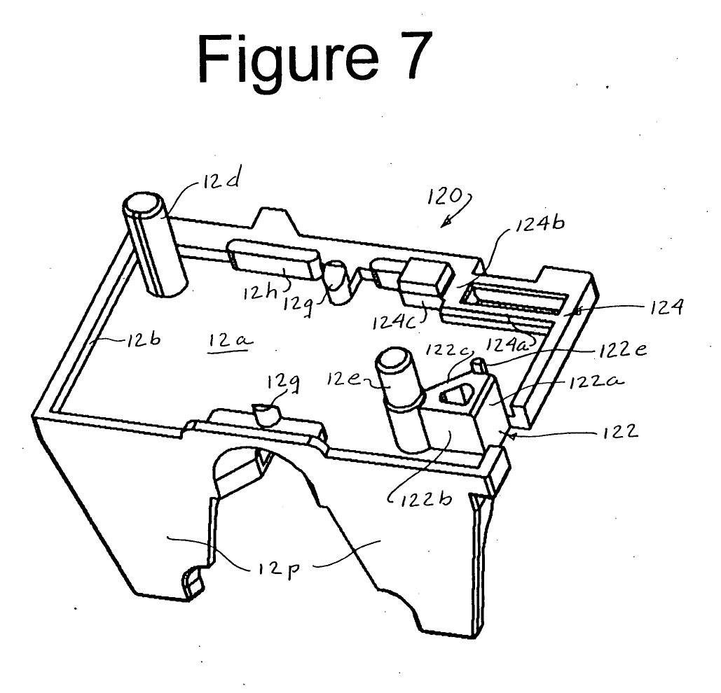

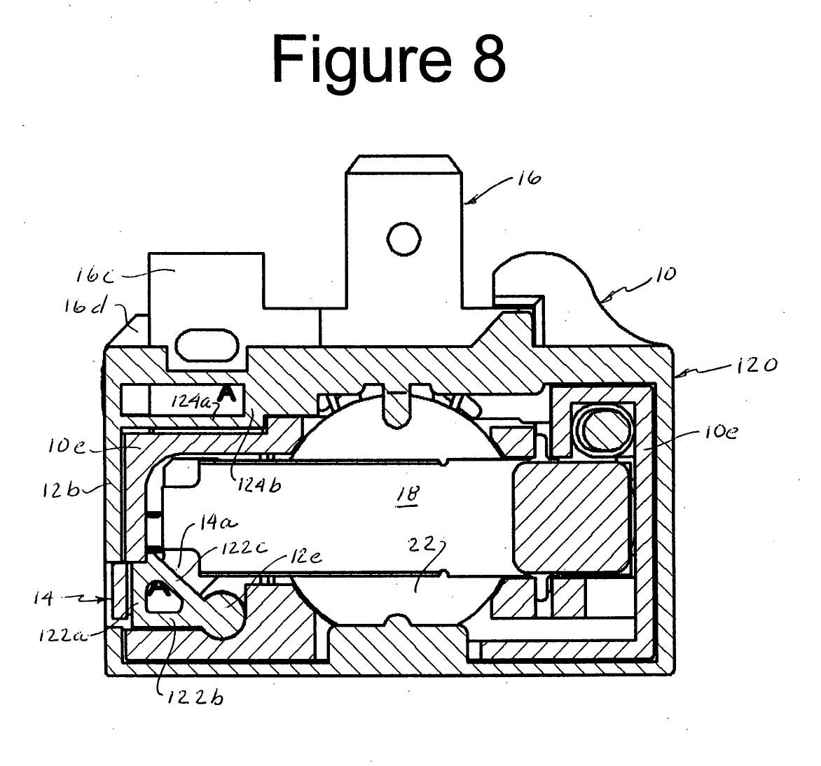

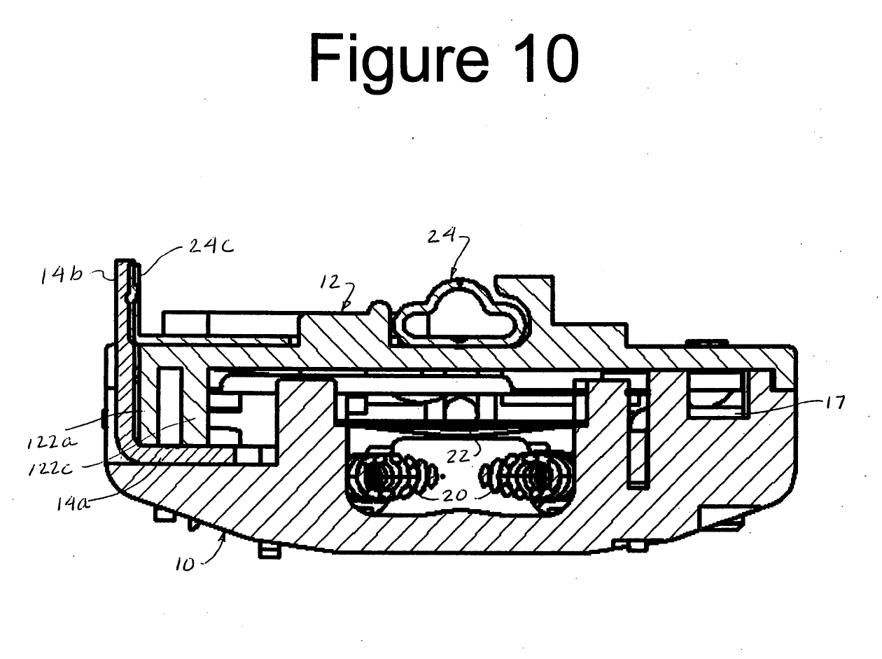

A modified cover 120 (see FIG. 7) made in accordance with a first feature of a preferred embodiment of the invention comprises a first multiple wall barrier 122 extending from recess closing wall 12a comprising a first wall 122a orthogonally from wall 12a and disposed so that it is essentially flush with the inner surface of terminal receiving slot 10o and extends from the recess closing wall 12a generally to horizontally extending flat portion 14b of terminal 14 when the cover is received on the base (see FIG. 10). Extending generally normal to wall 122a at a side of slot 10o closest to ears 12p is a second wall 122b which extends over to guide pin 12e and then a third wall 122c extends between the extremity of wall 122a and post 12e generally forming a triangular barrier wall that extends normally from recess closing wall 12a that not only serves to interrupt arc travel but also reduces the volume of free space between the cover and the base, that is, it reduces the amount of fuel for supporting combustion. Preferably, a notch 122d (FIG. 8), extending in a normal direction to recess closing wall 12a is formed in walls 122a and 122c at their intersection that is adapted to receive the side wall 10e of the base to further impede arc travel. Preferably, a portion of wall barrier 122 along wall 122c that forms notch 122d is extended at 122e a distance essentially the same as the thickness of a mounting portion 14a of terminal 14. When the cover is in plan, this extension, or knob is received in a small open space next to mounting portion 14a extending toward opening 10t. This triangular feature essentially closes off the first path 2a of arc travel.

A second multiple wall barrier 124 is formed in the cover so that when placed on the base the barrier is at the first end of the housing adjacent to contacts 14c, 18a along the outer periphery. The second barrier adds wall 124a which extends normal to recess closing wall 12a and generally parallel to side wall 12b relative to the major length of the elongated base and spaced therefrom. Wall 124a extends away from recess closing wall 12a a distance essentially the same as outer wall 12b. Wall 124a at its extremity away from side wall 12b on the minor length end of the cover is joined to side wall 12b on the major length side by wall 124b of the same height. Contiguous to barrier 124 and extending along side wall 12b in the direction of its longitudinal axis, i.e., major length, is a block 124c, preferably formed of the same material as the cover, the block extending vertically a distance greater than that of side wall 12b. Block 124c serves as an arc barrier filling in the space 10r between wall portion 10e, 10e1 adjacent to stop 16e of conductive strip 16d defined by the back part of the contact receiving recess and wall portion 10f in back of the central heater receiving portion of the recess.

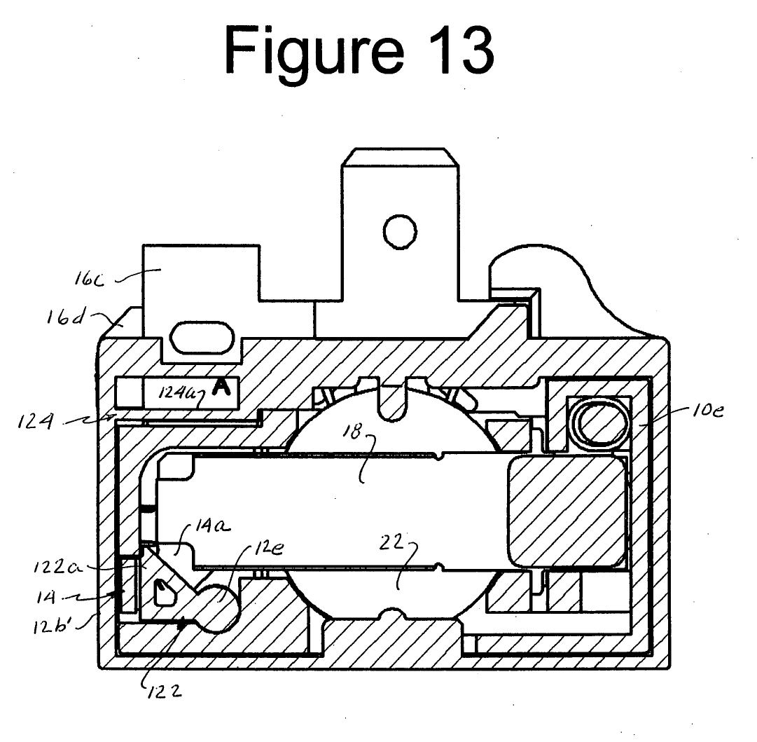

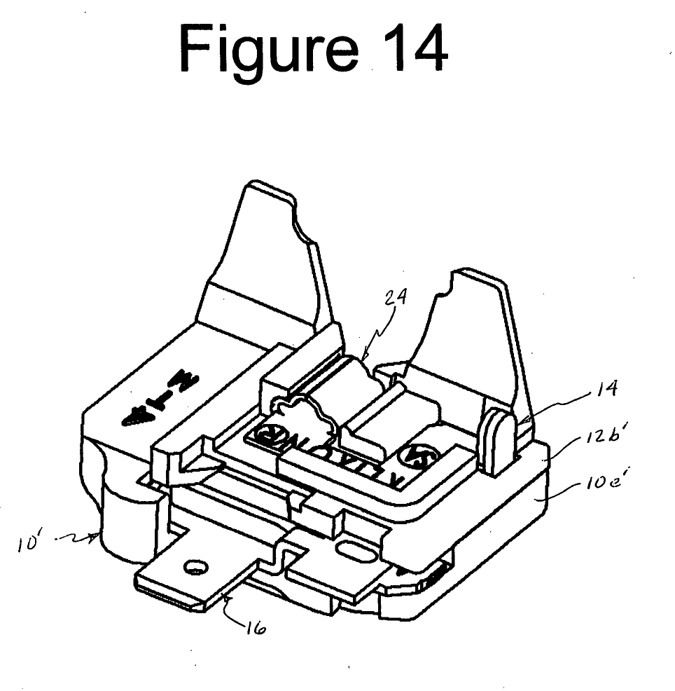

According to an alternative embodiment, terminal portion 14b can be moved inwardly away from the outer periphery of the housing as seen in FIGS. 13 and 14 with side wall portions 10e′ and 12b′ being continuous, that is, without slot 10o and 12c being formed in the side walls with wall 122a of the first barrier 122 essentially butted up against side wall 10e just beyond slot 10o. In this case, barrier 122, if desired, could be formed without notch 122d with barrier wall 122a butted up against sidewall 10e just beyond slot 10o.

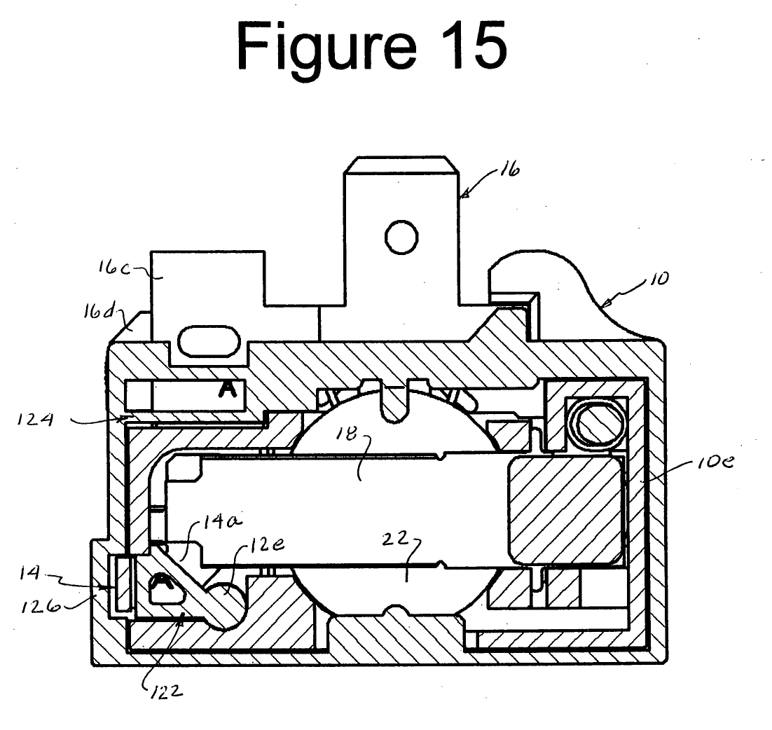

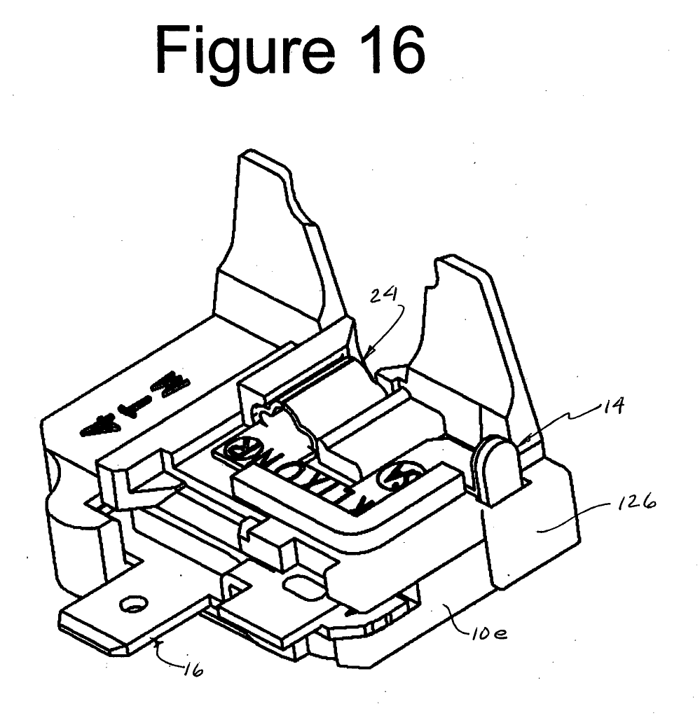

According to another alternative embodiment shown in FIGS. 15 and 16, the FIG. 1 structure can be modified by forming side wall portion 126 to extend across slot 10o externally thereof. The location of terminal 14 can remain as shown in FIG. 8 with a side wall 126 covering the slot 10o, 12c in side walls 10e of the base and 12b of the cover, respectively.

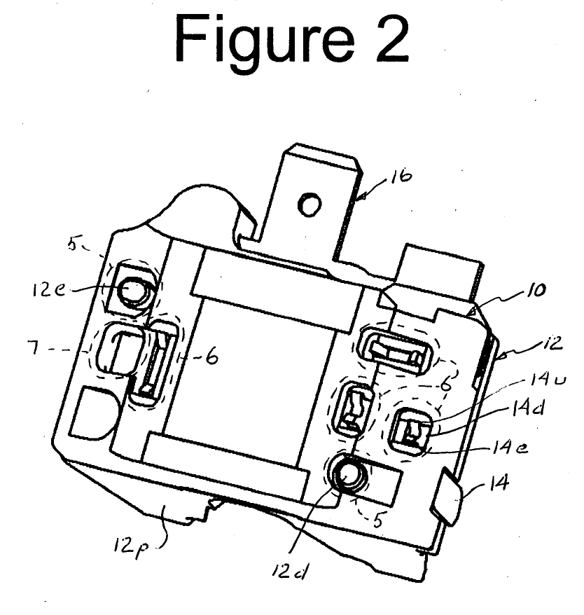

With reference to FIGS. 1 and 2 a number of openings are formed through the housing for various purposes, comprising openings at dashed lined locations 3 and 4 for terminals 14 and 16, 5 for guide pins 12d, 12e and 6 for clamping elements in the base and 7 for providing access to the movable contact arm mounting portion. In accordance with another embodiment of the invention, each of these openings, once the device is assembled, can be sealed with suitable epoxy. This can be done along with the above embodiments or in place of them, as desired.

Although the invention has been described with regard to specific embodiments thereof, many variation and modifications will become apparent to those of ordinary skill in the art. It is therefore, the intent that the appended claims be interpreted as broadly as possible in view of the prior art to include all such variations and modifications.

What is claimed:

1. An enclosed protector having a housing formed by a base and a cover, a generally elongated recess formed in the base and defined by side walls of the base, the recess having opposed first and second ends,
a first terminal mounted at one opposed end, the first terminal having a generally flat contact mounting portion disposed within the recess, the first terminal extending through an opening in a wall of the housing,
a stationary contact mounted on the mounting portion of the first terminal, an elongated movable contact arm having first and second ends, a second terminal mounted on the base, an electrically conductive movable contact arm mounting platform electrically connected to the second terminal is disposed at the second end of the recess, the second end of the movable contact arm being electrically connected to the platform, a movable contact mounted on the first end of the movable contact arm and arranged to move into and out of engagement with the stationary contact,
a thermostat metal element positioned in the recess and arranged to move the movable contact arm at preselected thermal conditions and in turn move the movable contact out of engagement with the stationary contact,
the base formed with a terminal receiving ledge adjacent the first end of the recess, an electrically conductive portion received on the terminal receiving ledge and being electrically connected to the second terminal,
a cover received over the base, wherein the improvement comprising a side wall on the cover having spaced apart wall portions received on the first terminal closely adjacent to the stationary and movable contacts forming a first multiple wall barrier to limit travel of arcing from the contacts, the side wall of the cover having additional spaced apart wall portions along the perimeter of the base at the first end of the recess adjacent to the terminal receiving ledge forming a second multiple wall barrier to limit travel of arcing from the contacts.

2. A protector according to claim 1 in which the wall portions of the first multiple wall barrier are joined to one another to form a hollow triangular wall barrier.

3. A protector according to claim 1 in which an upstanding notch is formed between two barrier wall portions of the first multiple wall barrier and the side wall of the base is received in the notch.

4. A protector according to claim 3 in which one side of the notch is extended in length a distance essentially the same as the thickness of the contact mounting portion of the first terminal and is received adjacent to the contact mounting portion.

5. A protector according to claim 1 further comprising another side wall portion of the cover adjacent to the multiple wall barrier but disposed externally of the first terminal.

6. A protector according to claim 1 in which the wall portions of the second multiple barrier walls lie in respective planes which are generally parallel with each other.

7. A protector according to claim 1 in which the housing is formed with openings and further comprising epoxy filling each opening to provide an environmental seal.

8. An enclosed protector comprising:
a base, a generally elongated recess formed in the base and defined by side walls of the base, the recess having opposed first and second ends,
a first terminal extending through a slot formed through a side wall of the base at one opposed end, the first terminal having a generally flat contact mounting portion disposed within the recess,
a stationary contact mounted on the mounting portion of the first terminal,
an elongated movable contact arm having first and second ends, a second terminal having a mounting platform at the second end of the recess,
the second end of the movable contact arm mounted on the mounting platform, a movable contact mounted on the first end of the movable contact arm and arranged to move into and out of engagement with the stationary contact,
a cover received over the base, the cover having a side wall having first and second multiple wall barriers in which one barrier is aligned with a portion of the first terminal and the second barrier includes spaced, parallely extending wall portions along the perimeter of the base at the first end of the recess, the first and second multiple wall barriers serving to limit travel of arcing from the contacts.
